(19) United States
(12) Patent Application Publication
(10) Pub. No.: US 2021/0343175 A1
(43) Pub. Date: Nov. 4, 2021

(54) SYSTEMS AND METHODS FOR ADAPTIVE ASSESSMENT

(71) Applicant: Pearson Education, Inc., Bloomington, MN (US)

(72) Inventor: Zhaodong WANG, San Jose, CA (US)

(21) Appl. No.: 16/866,117

(22) Filed: May 4, 2020

(51) Int. Cl. G09B 7/04

(52) U.S. Cl. CPC G09B 7/04; G09B 19/04

(57) ABSTRACT

Systems and methods for adaptive assessment may utilize test deliver policies derived from a multi-armed bandit approach in combination with an item response theory model. A monotonic policy may involve defining a difficulty range according to which test items are selected for delivery during an assessment, where the difficulty range is updated following delivery of each test item based on test-taker performance. A multi-stage policy may implement several stages for test item delivery, with a different initial difficulty range for test item selection being defined for each stage and the difficulty ranges being updated based on test-taker performance within each respective stage. A probability matching policy may involve defining an item difficulty probability distribution according to which test items are selected for delivery to a test taker, where the probability distribution is initialized based on test taker skill level and updated based on test taker performance.

### FIELD OF THE INVENTION

This disclosure relates to the field of systems and methods configured to provide interactive electronic learning environments and adaptive electronic assessment.

### BACKGROUND

Spoken language tests have been widely used in education, immigration, employment and many other social activities. Among the well-known spoken language tests are TOEFL, IELTS, Pearson Test of English-Academic (PTE-A), etc. These tests are accepted for the robustness and accuracy in language ability assessment. Automatic speech recognition (ASR) was introduced into spoken language tests around the beginning of the 21st century. With modern speech recognition techniques, word error rate may be as low as 3%. In the past several years, automatic scoring of spoken language tests by automatic ASR has been introduced and online adaptive spoken language tests test has become practical. These developments in spoken language testing have generally been welcomed by the market, but have received some complaints due to excessive length of test items.

A conventional spoken English test designed for automatic scoring using ASR could, for example, include 25 test items and 5 item types and would last for 1.5 hour. This conventional test design was intended to maintain high robustness and work as contingency reserve for ASR. Word errors introduced in ASR is a typical factor that affects the score accuracy. A typical traditional (e.g., non-ASR) test is usually two-thirds of the size of a conventional ASR test. Conventional ASR test design tends to involve a tradeoff between test length versus accuracy/stability.

Thus, there remains a need for improved ASR-based spoken language test design policies and techniques.

### SUMMARY OF THE INVENTION

Embodiments of the present invention relate to systems and methods by which adaptive assessments may be delivered to test-takers according to dynamic policies that may utilize item response theory modeling and a multi-armed bandit based approach.

In an example embodiment, a system may include a server that is in electronic communication with a user device associated with a user account. The server may include a processor and a memory device. The memory device may be configured to store computer-readable instructions, which, when executed, cause the processor to initiate an assessment, select a first test item from a test item bank based on first test item selection parameters, cause a client device to deliver the first test item, receive first response data from the client device, perform analysis of the first response data, produce second test item selection parameters by modifying the first test item selection parameters based on the analysis of the first response data, select a second test item from the test item bank based on the second test item selection parameters, cause the client device to deliver the second test item, determine that an end condition has been met, and responsive to determining that the end condition has been met, end the assessment.

In some embodiments, the first response data may include recorded speech data. Performing analysis of the first response data may include executing a speech recognition algorithm to identify and extract words from the recorded speech data.

In some embodiments, performing analysis of the first response data may include generating a score based on the first response data, updating an item response theory model based on the score, updating a confidence level associated with the item response theory model, responsive to updating the confidence level, determining a change in the confidence level, and generating a reward value based on the change in the confidence level. The second test item selection parameters may be generated based on the score and the reward value.

In some embodiments, the first test item selection parameters may include a first difficulty range. The second test item selection parameters may include a second difficulty range. The computer-readable instructions, when executed, may further cause the processor to generate a random number, determine that the reward value exceeds a predetermined threshold, determine that the random number exceeds a predetermined probability threshold, and, responsive to determining that the reward value exceeds the predetermined threshold and that the random number exceeds the predetermined probability threshold, increasing the first difficulty range of the first test item selection parameters to the second difficulty range of the second test item selection parameters.

In some embodiments, selecting the second test item may include randomly selecting the second test item from a group of test items of the test item bank. The group of test items may include only test items having difficulty values within the second difficulty range. The difficulty values of the test items of the group of test items may be calculated using the item response theory model.

In some embodiments, the first test item selection parameters may include a first probability distribution, and the second test item selection parameters may include a second probability distribution. Updating the item response theory model may include updating a user skill level of a user to which the test is being delivered based on the score. The computer-readable instructions, when executed, further cause the processor to, responsive to updating the user skill level, generate the second probability distribution based on the update user skill level and the reward value.

In some embodiments, selecting the second test item may include selecting the second test item from a group of test items of the test item bank according to the second probability distribution, such that a probability of selecting a given test item of the group of test items having a difficulty value determined by the item response theory mode is defined by the second probability distribution.

In some embodiments, determining that the end condition has been met may include determining that a predetermined number of test items have been delivered.

In an example embodiment, a system may include a server that is in electronic communication with a user device associated with a user account. The server may include a processor and a memory device configured to store computer readable instructions, which, when executed, cause the processor to initiate an assessment, a random number, select a first test item based on test item selection parameters and the random number, the first test item selection parameters defining a first difficulty range, the first test item having a first difficulty value that is within the difficulty range, cause a client device to deliver the first test item, receive first response data from the client device, perform analysis of the first response data, update the test item selection parameters by increasing the first difficulty range to a second difficulty range based on the analysis of the first response data, generate a second random number, select a second test item having a second difficulty value within the second difficulty range based on the second random number, the client device to deliver the second test item, determine that a first end condition has been met, and end the assessment.

In some embodiments, the first response data may include recorded speech data. Performing analysis of the first response data may include executing a speech recognition algorithm to identify and extract words from the recorded speech data.

In some embodiments, performing analysis of the first response data may include generating a score based on the first response data, updating an item response theory model based on the score, the first difficulty value and the second difficulty value being determined based on the item response theory model, updating a confidence level associated with the item response theory model, responsive to updating the confidence level, determining a change in the confidence level, and generating a reward value based on the change in the confidence level. The second test item selection parameters may be generated based on the score and the reward value.

In some embodiments, the computer-readable instructions, when executed, may further cause the processor to determine that the reward value exceeds a predetermined threshold, and determine that the random number exceeds a predetermined probability threshold. The second difficulty range may be generated responsive to determining that the reward value exceeds the predetermined threshold and that the random number exceeds the predetermined probability threshold.

In some embodiments, determining that the first end condition has been met may include determining that a predetermined number of test items have been delivered.

In some embodiments, the computer-readable instructions, when executed, may further cause the processor to determine that the first end condition has been met by determining that a first predetermined number of test items have been delivered during a first stage, the first difficulty range having a predefined association with the first stage, responsive to determining that the first predetermined number of test items have been delivered, end the first stage, initiate a second stage, and update the item selection parameters to include a third difficulty range having a predefined association with the second stage, generate a third random number, select a third test item having a third difficulty value within the third difficulty range based on the third random number, cause the client device to deliver the third test item, and determine that a second end condition has been met by determining that a second predetermined number of test items have been delivered. Ending the assessment may be performed responsive to determining that the second end condition has been met.

In an example embodiment, a system may include a server that is in electronic communication with a user device associated with a user account. The server may include a processor and a memory device configured to store computer-readable instructions, which, when executed, cause the processor to initiate an assessment, select a first test item from a test item bank based on a first item difficulty probability distribution, cause a client device to deliver the first test item to a user, receive first response data from the client device corresponding to a first response submitted by the user, generate a second item difficulty probability distribution based on the first response data, select a second test item from the test item bank based on the second item difficulty probability distribution, cause the client device to deliver the second test item to the user, determine that an end condition has been met, and responsive to determining that the end condition has been met, end the assessment.

In some embodiments, the first response data may include recorded speech data. Performing analysis of the first response data may include executing a speech recognition algorithm to identify and extract words from the recorded speech data.

In some embodiments, the computer-readable instructions, when executed, may further cause the processor to generate a score based on the first response data, update an item response theory model based on the score, a first difficulty value of the first test item and a second difficulty value of the second test item being determined based on the item response theory model, update a confidence level associated with the item response theory model, responsive to updating the confidence level, determine a change in the confidence level, and generate a reward value based on the change in the confidence level. The second test item selection parameters may be generated based on the score and the reward value.

In some embodiments, updating the item response theory model may include updating a user skill level of the user based on the score. The second item difficulty probability distribution may be generated based on the user skill level and the reward value.

In some embodiments, a probability of the second test item being selected may be defined by the second probability distribution based on the difficulty value of the second test item.

In some embodiments, determining that the end condition has been met may include determining that a predetermined number of test items have been delivered to the user via the client device.

The above features and advantages of the present invention will be better understood from the following detailed description taken in conjunction with the accompanying drawings.

### BRIEF DESCRIPTION OF THE DRAWINGS

FIG. 1 illustrates a system level block diagram showing data stores, data centers, servers, and clients of a distributed computing environment, in accordance with an embodiment.

FIG. 2 illustrates a system level block diagram showing physical and logical components of a special-purpose computer device within a distributed computing environment, in accordance with an embodiment.

FIG. 3 shows an illustrative logical diagram representing a process flow for a spoken language adaptive assessment that is automatically scored, in accordance with an embodiment.

FIG. 4 shows an illustrative process flow for a method by which a general multi-armed bandit model may be applied to guide test item selection for an assessment, in accordance with an embodiment.

FIG. 5 shows an illustrative process flow for a method by which a test item may be delivered, and a response maybe received and analyzed, in accordance with an embodiment.

FIG. 6 shows an illustrative process flow for a method of assessment delivery using a monotonic multi-armed bandit policy to guide test item selection, in accordance with an embodiment.

FIG. 7 shows an illustrative process flow for a method of assessment delivery using a multi-stage multi-armed bandit policy to guide test item selection, in accordance with an embodiment.

FIG. 8 shows an illustrative process flow for a method of assessment delivery using a probability matching multi-armed bandit policy to guide test item selection, in accordance with an embodiment.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

Network

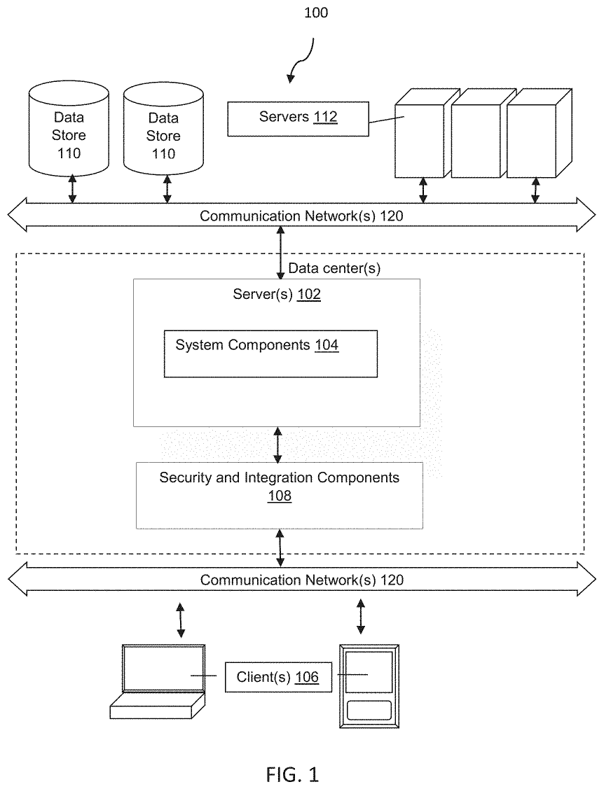

FIG. 1 illustrates a non-limiting example distributed computing environment 100, which includes one or more computer server computing devices 102, one or more client computing devices 106, and other components that may implement certain embodiments and features described herein. Other devices, such as specialized sensor devices, etc., may interact with client 106 and/or server 102. The server 102, client 106, or any other devices may be configured to implement a client-server model or any other distributed computing architecture.

Server 102, client 106, and any other disclosed devices may be communicatively coupled via one or more communication networks 120. Communication network 120 may be any type of network known in the art supporting data communications. As non-limiting examples, network 120 may be a local area network (LAN; e.g., Ethernet, Token-Ring, etc.), a wide-area network (e.g., the Internet), an infrared or wireless network, a public switched telephone networks (PSTNs), a virtual network, etc. Network 120 may use any available protocols, such as (e.g., transmission control protocol/Internet protocol (TCP/IP), systems network architecture (SNA), Internet packet exchange (IPX), Secure Sockets Layer (SSL), Transport Layer Security (TLS), Hypertext Transfer Protocol (HTTP), Secure Hypertext Transfer Protocol (HTTPS), Institute of Electrical and Electronics (IEEE) 802.11 protocol suite or other wireless protocols, and the like.

Servers/Clients

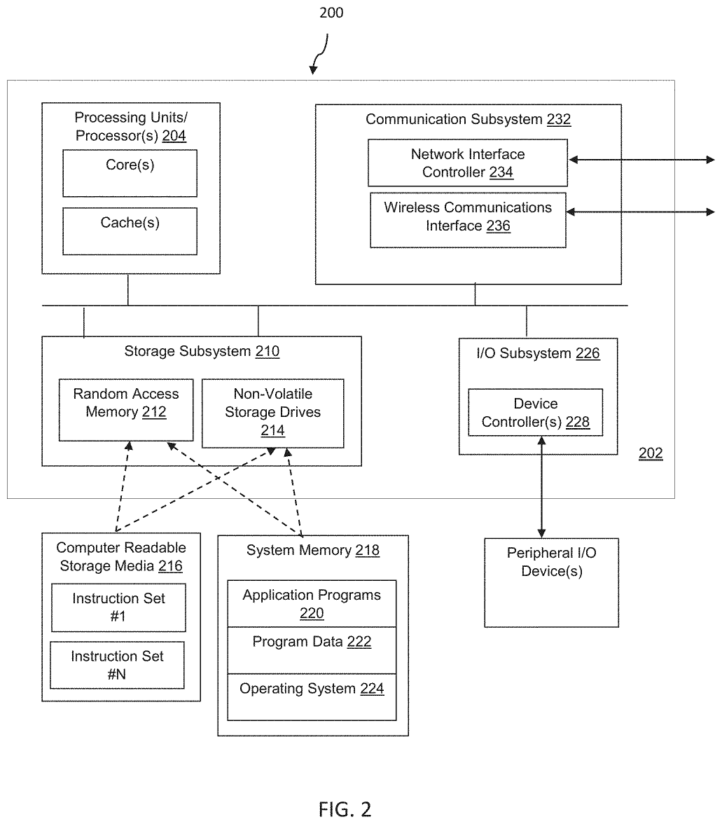

The embodiments shown in FIGS. 1-2 are thus one example of a distributed computing system and is not intended to be limiting. The subsystems and components within the server 102 and client devices 106 may be implemented in hardware, firmware, software, or combinations thereof. Various different subsystems and/or components 104 may be implemented on server 102. Users operating the client devices 106 may initiate one or more client applications to use services provided by these subsystems and components. Various different system configurations are possible in different distributed computing systems 100 and content distribution networks. Server 102 may be configured to run one or more server software applications or services, for example, web-based or cloud-based services, to support content distribution and interaction with client devices 106. Users operating client devices 106 may in turn utilize one or more client applications (e.g., virtual client applications) to interact with server 102 to utilize the services provided by these components. Client devices 106 may be configured to receive and execute client applications over one or more networks 120. Such client applications may be web browser based applications and/or standalone software applications, such as mobile device applications. Client devices 106 may receive client applications from server 102 or from other application providers (e.g., public or private application stores).

Security

As shown in FIG. 1, various security and integration components 108 may be used to manage communications over network 120 (e.g., a file-based integration scheme or a service-based integration scheme). Security and integration components 108 may implement various security features for data transmission and storage, such as authenticating users or restricting access to unknown or unauthorized users,

As non-limiting examples, these security components 108 may comprise dedicated hardware, specialized networking components, and/or software (e.g., web servers, authentication servers, firewalls, routers, gateways, load balancers, etc.) within one or more data centers in one or more physical location and/or operated by one or more entities, and/or may be operated within a cloud infrastructure.

In various implementations, security and integration components 108 may transmit data between the various devices in the content distribution network 100. Security and integration components 108 also may use secure data transmission protocols and/or encryption (e.g., File Transfer Protocol (FTP), Secure File Transfer Protocol (SFTP), and/or Pretty Good Privacy (PGP) encryption) for data transfers, etc.).

In some embodiments, the security and integration components 108 may implement one or more web services (e.g., cross-domain and/or cross-platform web services) within the content distribution network 100, and may be developed for enterprise use in accordance with various web service standards (e.g., the Web Service Interoperability (WS-I) guidelines). For example, some web services may provide secure connections, authentication, and/or confidentiality throughout the network using technologies such as SSL, TLS, HTTP, HTTPS, WS-Security standard (providing secure SOAP messages using XML encryption), etc. In other examples, the security and integration components 108 may include specialized hardware, network appliances, and the like (e.g., hardware-accelerated SSL and HTTPS), possibly installed and configured between servers 102 and other network components, for providing secure web services, thereby allowing any external devices to communicate directly with the specialized hardware, network appliances, etc.

Data Stores (Databases)

Computing environment 100 also may include one or more data stores 110, possibly including and/or residing on one or more back-end servers 112, operating in one or more data centers in one or more physical locations, and communicating with one or more other devices within one or more networks 120. In some cases, one or more data stores 110 may reside on a non-transitory storage medium within the server 102. In certain embodiments, data stores 110 and back-end servers 112 may reside in a storage-area network (SAN). Access to the data stores may be limited or denied based on the processes, user credentials, and/or devices attempting to interact with the data store.

Computer System

With reference now to FIG. 2, a block diagram of an illustrative computer system is shown. The system 200 may correspond to any of the computing devices or servers of the network 100, or any other computing devices described herein. In this example, computer system 200 includes processing units 204 that communicate with a number of peripheral subsystems via a bus subsystem 202. These peripheral subsystems include, for example, a storage subsystem 210, an I/O subsystem 226, and a communications subsystem 232.

Processors

One or more processing units 204 may be implemented as one or more integrated circuits (e.g., a conventional micro-processor or microcontroller), and controls the operation of computer system 200. These processors may include single core and/or multicore (e.g., quad core, hexa-core, octo-core, ten-core, etc.) processors and processor caches. These processors 204 may execute a variety of resident software processes embodied in program code, and may maintain multiple concurrently executing programs or processes. Processor(s) 204 may also include one or more specialized processors, (e.g., digital signal processors (DSPs), outboard, graphics application-specific, and/or other processors).

Buses

Bus subsystem 202 provides a mechanism for intended communication between the various components and subsystems of computer system 200. Although bus subsystem 202 is shown schematically as a single bus, alternative embodiments of the bus subsystem may utilize multiple buses. Bus subsystem 202 may include a memory bus, memory controller, peripheral bus, and/or local bus using any of a variety of bus architectures (e.g. Industry Standard Architecture (ISA), Micro Channel Architecture (MCA), Enhanced ISA (EISA), Video Electronics Standards Association (VESA), and/or Peripheral Component Interconnect (PCI) bus, possibly implemented as a Mezzanine bus manufactured to the IEEE P1386.1 standard).

Input/Output

I/O subsystem 226 may include device controllers 228 for one or more user interface input devices and/or user interface output devices, possibly integrated with the computer system 200 (e.g., integrated audio/video systems, and/or touchscreen displays), or may be separate peripheral devices which are attachable/detachable from the computer system 200. Input may include keyboard or mouse input, audio input (e.g., spoken commands), motion sensing, gesture recognition (e.g., eye gestures), etc.

Input

As non-limiting examples, input devices may include a keyboard, pointing devices (e.g., mouse, trackball, and associated input), touchpads, touch screens, scroll wheels, click wheels, dials, buttons, switches, keypad, audio input devices, voice command recognition systems, microphones, three dimensional (3D) mice, joysticks, pointing sticks, gamepads, graphic tablets, speakers, digital cameras, digital camcorders, portable media players, webcams, image scanners, fingerprint scanners, barcode readers, 3D scanners, 3D printers, laser rangefinders, eye gaze tracking devices, medical imaging input devices, MIDI keyboards, digital musical instruments, and the like.

Output

In general, use of the term “output device” is intended to include all possible types of devices and mechanisms for outputting information from computer system 200 to a user or other computer. For example, output devices may include one or more display subsystems and/or display devices that visually convey text, graphics and audio/video information (e.g., cathode ray tube (CRT) displays, flat-panel devices, liquid crystal display (LCD) or plasma display devices, projection devices, touch screens, etc.), and/or non-visual displays such as audio output devices, etc. As non-limiting examples, output devices may include, indicator lights, monitors, printers, speakers, headphones, automotive navigation systems, plotters, voice output devices, modems, etc.

Memory or Storage Media

Computer system 200 may comprise one or more storage subsystems 210, comprising hardware and software components used for storing data and program instructions, such as system memory 218 and computer-readable storage media 216.

System memory 218 and/or computer-readable storage media 216 may store program instructions that are loadable and executable on processor(s) 204. For example, system memory 218 may load and execute an operating system 224, program data 222, server applications, client applications 220, Internet browsers, mid-tier applications, etc.

System memory 218 may further store data generated during execution of these instructions. System memory 218 may be stored in volatile memory (e.g., random access memory (RAM) 212, including static random access memory (SRAM) or dynamic random access memory (DRAM)). RAM 212 may contain data and/or program modules that are immediately accessible to and/or operated and executed by processing units 204.

System memory 218 may also be stored in non-volatile storage drives 214 (e.g., read-only memory (ROM), flash memory, etc.) For example, a basic input/output system (BIOS), containing the basic routines that help to transfer information between elements within computer system 200 (e.g., during start-up) may typically be stored in the non-volatile storage drives 214.

Computer Readable Storage Media

Storage subsystem 210 also may include one or more tangible computer-readable storage media 216 for storing the basic programming and data constructs that provide the functionality of some embodiments. For example, storage subsystem 210 may include software, programs, code modules, instructions, etc., that may be executed by a processor 204, in order to provide the functionality described herein. Data generated from the executed software, programs, code, modules, or instructions may be stored within a data storage repository within storage subsystem 210.

Storage subsystem 210 may also include a computer-readable storage media reader connected to computer-readable storage media 216. Computer-readable storage media 216 may contain program code, or portions of program code. Together and, optionally, in combination with system memory 218, computer-readable storage media 216 may comprehensively represent remote, local, fixed, and/or removable storage devices plus storage media for temporarily and/or more permanently containing, storing, transmitting, and retrieving computer-readable information.

Computer-readable storage media 216 may include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computer system 200.

By way of example, computer-readable storage media 216 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 216 may include, but is not limited to, Zip® drives, flash memory cards, universal serial bus (USB) flash drives, secure digital (SD) cards, DVD disks, digital video tape, and the like. Computer-readable storage media 216 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magneto-resistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 200.

Communication Interface

Communications subsystem 232 may provide a communication interface from computer system 200 and external computing devices via one or more communication networks, including local area networks (LANs), wide area networks (WANs) (e.g., the Internet), and various wireless telecommunications networks. As illustrated in FIG. 2, the communications subsystem 232 may include, for example, one or more network interface controllers (NICs) 234, such as Ethernet cards, Asynchronous Transfer Mode NICs, Token Ring NICs, and the like, as well as one or more wireless communications interfaces 236, such as wireless network interface controllers (WNICs), wireless network adapters, and the like. Additionally and/or alternatively, the communications subsystem 232 may include one or more modems (telephone, satellite, cable, ISDN), synchronous or asynchronous digital subscriber line (DSL) units, Fire Wire® interfaces, USB® interfaces, and the like. Communications subsystem 236 also may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components.

Input Output Streams Etc.

In some embodiments, communications subsystem 232 may also receive input communication in the form of structured and/or unstructured data feeds, event streams, event updates, and the like, on behalf of one or more users who may use or access computer system 200. For example, communications subsystem 232 may be configured to receive data feeds in real-time from users of social networks and/or other communication services, web feeds such as Rich Site Summary (RSS) feeds, and/or real-time updates from one or more third party information sources (e.g., data aggregators). Additionally, communications subsystem 232 may be configured to receive data in the form of continuous data streams, which may include event streams of real-time events and/or event updates (e.g., sensor data applications, financial tickers, network performance measuring tools, clickstream analysis tools, automobile traffic monitoring, etc.). Communications subsystem 232 may output such structured and/or unstructured data feeds, event streams, event updates, and the like to one or more data stores that may be in communication with one or more streaming data source computers coupled to computer system 200.

Connect Components to System

The various physical components of the communications subsystem 232 may be detachable components coupled to the computer system 200 via a computer network, a FireWire® bus, or the like, and/or may be physically integrated onto a motherboard of the computer system 200. Communications subsystem 232 also may be implemented in whole or in part by software.

Other Variations

Due to the ever-changing nature of computers and networks, the description of computer system 200 depicted in the figure is intended only as a specific example. Many other configurations having more or fewer components than the system depicted in the figure are possible. For example, customized hardware might also be used and/or particular elements might be implemented in hardware, firmware, software, or a combination. Further, connection to other computing devices, such as network input/output devices, may be employed. Based on the disclosure and teachings provided herein, a person of ordinary skill in the art will appreciate other ways and/or methods to implement the various embodiments.

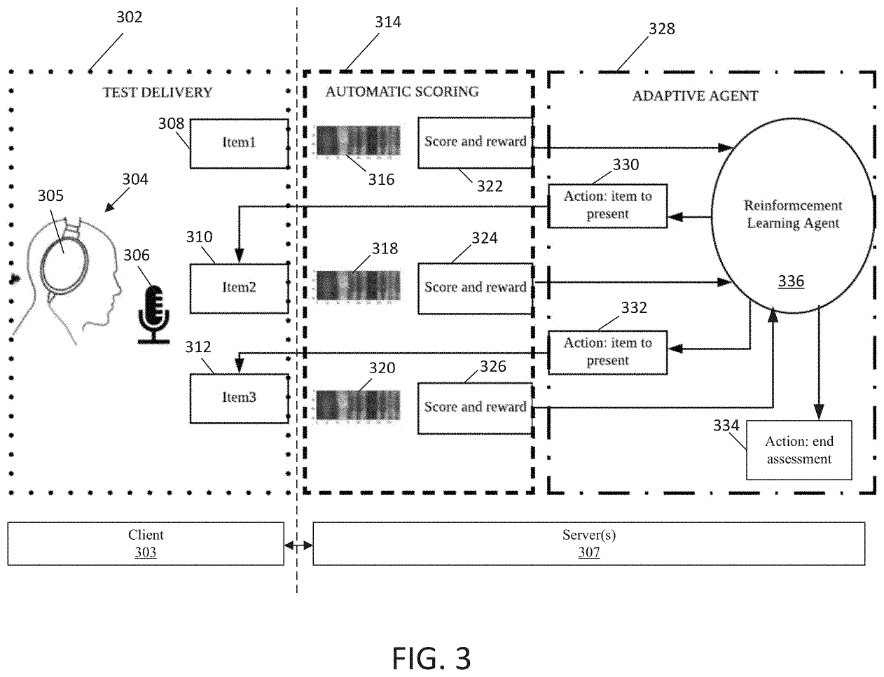

FIG. 3 shows an illustrative logical diagram representing a process flow for an automatically scored spoken language adaptive assessment.

Generally, an adaptive assessment may involve a test taker, test items, an item bank, response scores, rewards, and confidence levels. A test taker (sometimes referred to herein as a “user”) may be defined as a unique individual to whom the adaptive learning assessment is delivered. A test item may be defined as a spoken language prompt that may be associated with a unique test item identifier (ID). For example, a test taker may provide one verbal response to a given test item. A test item may have a difficulty level (e.g., which may be characterized by a “difficulty value”) and a difficulty standard deviation, which may be determined via execution of an item response theory (IRT) model, as will be described. Test items that are delivered to the test taker may first be selected from a test bank (i.e., a collection of test items) that may be stored in a computer memory device. Response data may be generated corresponding to a given verbal response to a test item, which may be analyzed by a server (e.g., by one or more processors of such a server) to generate a score/reward pair.

A score/reward pair may include a response score and a reward. A response score may be automatically generated by comparing response data representing a response to a test item to an expected response and/or predefined response criteria. The response score may characterize how closely the response data matches the expected response and/or meets the predefined response criteria. The reward may represent a gain in a confidence level representing the amount of confidence that a corresponding, automatically generated response score matches (e.g., exactly matches or is within a predefined range of) the response score predicted by an IRT model.

An IRT model may be implemented to estimate user ability levels of test takers and difficulty levels of test items. The IRT model generally specifies a functional relationship between a test taker's latent trait level (“user ability level”) and an item level response. The IRT approach then attempts to model an individual's response pattern by specifying how their underlying user ability level interacts with one or more characteristics (e.g., difficulty, discrimination, and/or the like) of a test item. Historical data representing the performance (e.g., scored responses) of a group of test takers when responding to a group of test items may be analyzed and fit to an IRT model to estimate the difficulty of each test item in the group of test items and the user ability level of each test taker in the group of test takers.

An expected probability that a given test taker will correctly respond to a given test item may be determined using the IRT model when the user ability level of the test taker and the difficulty level of the test item are known. A confidence level may be updated for the IRT model each time a response is submitted to a test item by a test-taker, with the confidence level increasing when a corresponding response score substantially matches (e.g., is within a predefined threshold range of) a response score predicted by the IRT model, and decreasing when the corresponding response score does not closely match score (e.g., is outside of a predefined threshold range of) the predicted response. Additionally, expected a-posteriori (EAP) or maximum a-posterior (MAP) methods using an equally spaced quadrature may be used to estimate ability scores for test takers based on their input responses to test items for which difficulty and/or discrimination values have already been determined using the IRT model.

In the present example, the adaptive assessment process is divided into three separate logical blocks: a test delivery block 302, an automatic scoring block 314, and an adaptive agent block 328.

The test delivery block 302 may include a client device 303 (e.g., client 106, FIG. 1; system 200, FIG. 2), which may be communicatively coupled to an audio output device 305 (e.g., headphones, speakers, and/or the like) and to an audio input device 306 (e.g., a microphone). The client device 303 delivers test items 308, 310, 312 to a test taker 304 (“user” 304) via the audio output device 305 and/or an electronic screen (not shown) of the client device 303. Verbal responses of the user may be received by the audio input device 306 and converted into response data 316, 318, 320, (e.g., converted into audio data). The test items 308, 310, 312, may each be associated with corresponding difficulty scores and discrimination scores determined by the server(s) 307 using an IRT model, as described above. As test items are delivered to the test taker 304, an ability level may be determined for the test taker 304 using the IRT model. This ability level may be used as a basis modifying test item selection parameters (e.g., parameters defining how test items to be delivered to the test taker 304 are selected by the reinforcement learning agent 336).

The automated scoring block 314 may include one or more servers 307 (e.g., servers 112, FIG. 1 and/or system 200, FIG. 2) that is configured to receive the response data from the client device 303, and to, for each response represented in the response data 316, 318, 320, generate a score/reward pair 322, 324, 326. For example, the server(s) 307 may execute a speech recognition algorithm to identify words and/or sentences within the response data 316, 318, 320, and may extract those words and/or sentences. The extracted words and/or sentences may then be analyzed to create the score/reward pairs 322, 324, 326. For example, to generate scores of the score/reward pairs 322, 324, 326, the extracted words and/or sentences may be compared to scoring/grading criteria defined in one or more databases stored in the server(s) 307 for each of the items 308, 310, 312, respectively. Each time a score is calculated, the IRT model may be updated (e.g., as the score will generally cause the difficulty and discrimination scores of the corresponding test item to be modified and cause the ability score of the test-taker to be modified), and a confidence level associated with the IRT model may be recalculated. To generate reward values for the score/reward pairs 322, 324, 326, the server(s) 307 may determine an amount by which the new score increases or decreases a confidence level associated with the IRT model.

The adaptive agent block 328 includes a reinforcement learning agent 336, which may be executed by one or more of the servers 307 that is communicatively coupled to the client 303. In some embodiments, the server that executes the reinforcement learning agent 336 may be the same server that generates the score/reward pairs 322, 324, 326 in the automatic scoring block 314. In other embodiments, these servers may be separate devices that are communicatively coupled to one another.

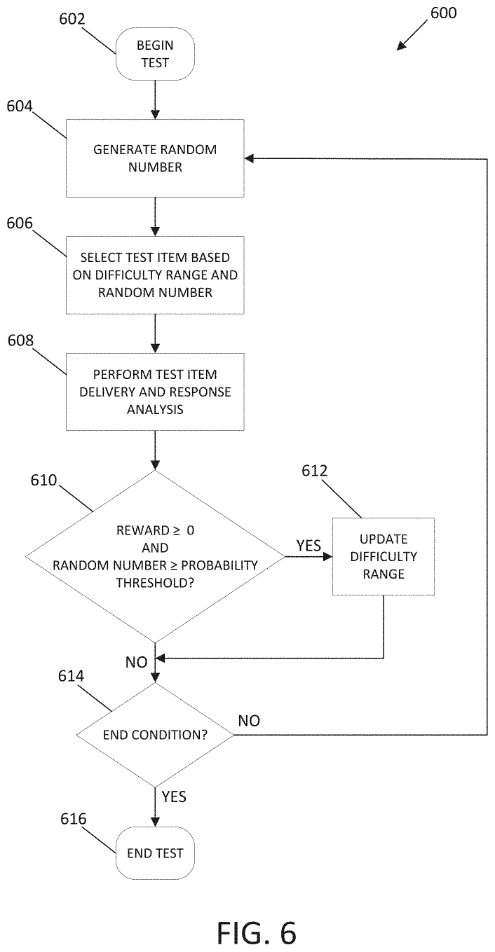

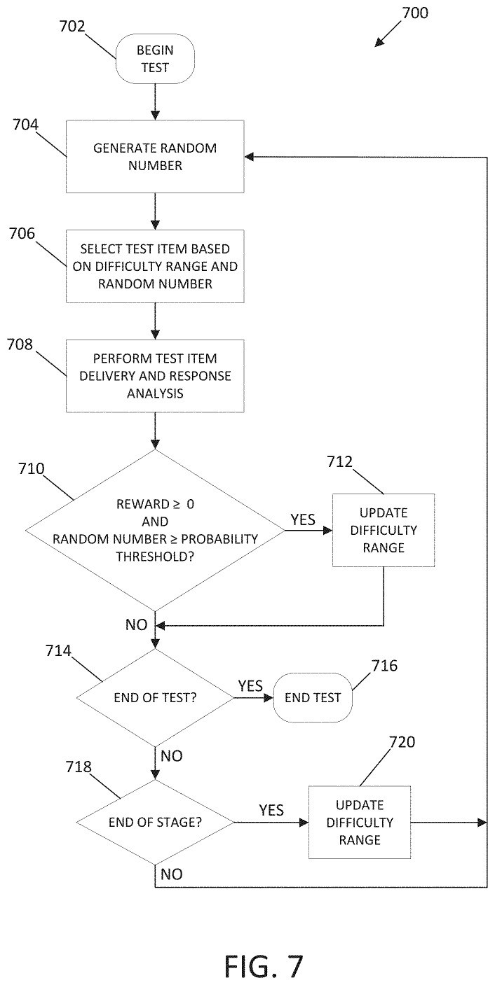

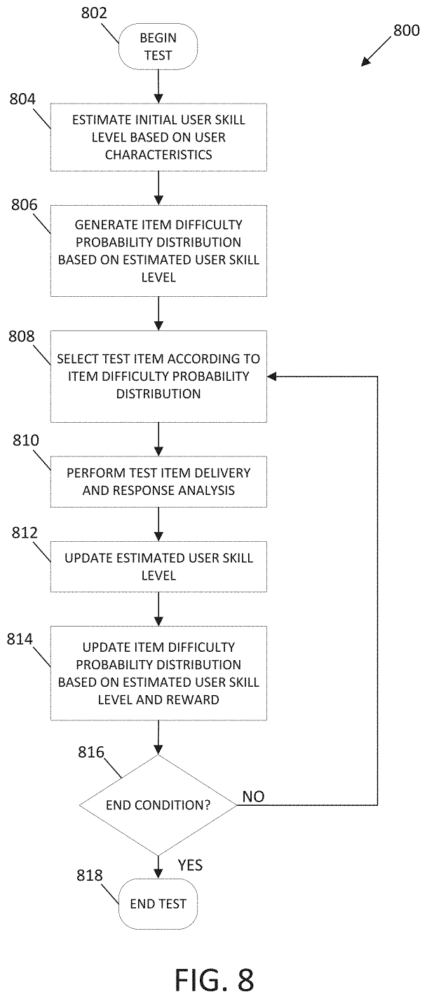

The reinforcement learning agent 336 may receive the score/reward pairs 322, 324, 326, and may then determine the next action that should be taken in the assessment delivery process. For example, the reinforcement learning agent 336 may select the next test item to present to the test-taker 304 based on the score and/or reward corresponding to the most recently presented test item and/or based on an estimated user ability level of the test-taker 304, which may be estimated using the IRT model. The reinforcement learning agent 336 may perform this test item selection according to a defined policy, such as a monotonic policy (e.g., corresponding to the method 600 of FIG. 6), a multistage policy (e.g., corresponding to the method 700 of FIG. 7), or a probability matching policy (e.g., corresponding to the method 800 of FIG. 8).

For example, a first test item 308 may be delivered to the test taker 304 by the client device 303 via the audio output device 305. A first verbal response given by the test taker 304 may be captured by the audio input device 306, and converted into first response data 316. The server 307 may generate a first score/reward pair 322 based on the first response data 316 as compared to an expected response and/or predefined response criteria that is defined in a memory device of the server 307 for the first test item 308. The first score/reward pair 322 may be sent to the reinforcement learning agent 336, which may update one or more test item selection parameters (e.g., a test item probability distribution, a difficulty range, and/or the like) before performing action 330 to select a second test item 310 to present to the user 304 based on the one or more test item selection parameters.

The second test item 310 may then be delivered to the test taker 304 by the client device 303 via the audio output device 305. A second verbal response given by the test taker 304 may be captured by the audio input device 306, and converted into second response data 318. The server 307 may generate a second score/reward pair 322 based on the second response data 318 as compared to an expected response and/or predefined response criteria that is defined in a memory device of the server 307 for the first test item 308. The second score/reward pair 324 may be sent to the reinforcement learning agent 336, which may update one or more test item selection parameters (e.g., a test item probability distribution, a difficulty range, and/or the like) before performing action 332 to select a third test item 312 to present to the user 304 based on the one or more test item selection parameters.

The third test item 312 may then be delivered to the test taker 304 by the client device 303 via the audio output device 305. A third verbal response given by the test taker 304 may be captured by the audio input device 306, and converted into third response data 320. The server 307 may generate a second score/reward pair 322 based on the third response data 320 as compared to an expected response and/or predefined response criteria that is defined in a memory device of the server 307 for the third test item 312. The third score/reward pair 326 may be sent to the reinforcement learning agent 336, which may determine that an end condition has been met (e.g., that a predetermined number of test items, in this case 3, have been delivered to the test taker 304) before performing action 334 to end the assessment delivery process.

While the present example involves the delivery of only three test items, it should be understood that, in other embodiments, additional or fewer test items may be delivered to the test taker 304 before the assessment delivery process is ended.

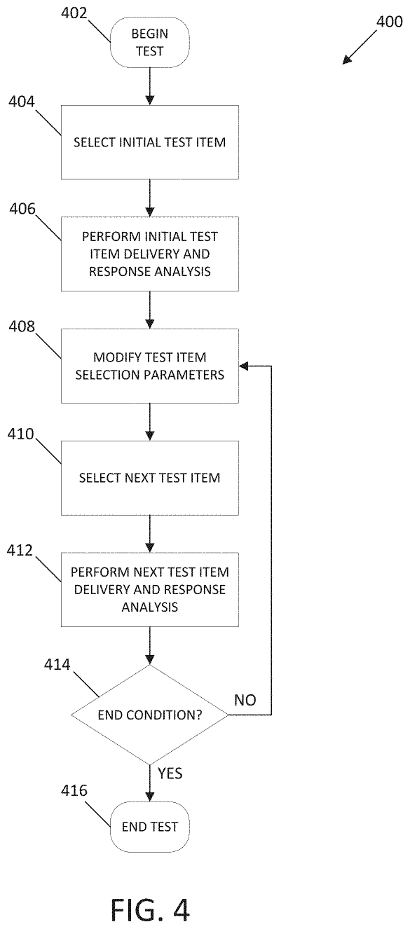

FIG. 4 shows an illustrative method 400 by which a general multi-armed bandit model may be applied to guide test item selection for an assessment. For example, some or all of the steps of the method 400 may be executed by one or more computer processors of one or more servers (e.g., servers 112, 307, FIGS. 1, 3) and/or one or more client devices (e.g., client devices 106, 303, FIGS. 1, 3). For example, in order to perform the steps of the method 400, the one or more computer processors may retrieve and execute computer-readable instructions that are stored in one or more memory devices of the one or more servers and/or one or more client devices.

At step 402, the test (“assessment”) begins. For example, the test may be a spoken language adaptive assessment that is automatically scored by a server, and that is delivered to a test taker via a client device.

At step 404, the server selects an initial (“first”) test item to be delivered to the test taker via the client device. For example, selection of the initial test item may be performed based on one or more initial (“first”) test item selection parameters, which may include difficulty ranges or probability distributions defining one or more subsets of test items within a test item bank (e.g., which may be stored in memory device that is included in or coupled to the server), where items of the one or more subsets are available for selection as the initial test item to be delivered to the test taker, while test items not included in the one or more subsets are not available for such selection.

In some embodiments, a subset of test items may include all test items having difficulty values (e.g., as determined by an IRT model) within a predefined difficulty range. In such embodiments, the predefined difficulty range would be considered the test item selection parameter.

In some embodiments, one or more weighted subsets of test items may be defined according to a predefined probability distribution, such that test items with lower weights have a lower probability of being selected as the initial test item, while test items with higher weights have a higher probability of being selected as the initial test item. The probability distribution may be generated based on difficulty values of the test items and/or an estimated ability level of the test taker. In such embodiments, the predefined probability distribution would be considered the test item selection parameter.

The initial test item may be selected from the one or more subsets of test items by the server randomly (e.g., with equal probability or according to a defined probability distribution) in accordance with the test item selection parameter being used.

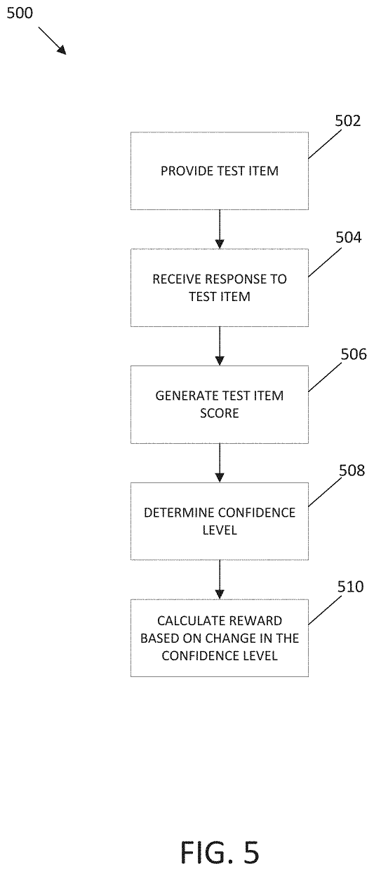

At step 406, the server performs an initial test item delivery and response analysis in which the initial test item is provided to the test taker and a corresponding response is given by the test taker and received via the client device. A reward value may be determined by the server based on the analysis of the response. In some embodiments, the response may include audio data representing a verbal response provided by a test taker, and the analysis of the response may include execution of an automated speech recognition algorithm, which may identify and extract words and/or sentences from the audio data of the response. For example, the delivery and response analysis performed at step 406 may correspond to the method 500 of FIG. 5, described below.

At step 408, the server modifies the test item selection parameters (e.g., difficulty range and/or probability distribution) based on one or more factors, which may include the reward value determined at step 406 or step 412. In some embodiments, the test item selection parameters may also be adjusted at a predefined interval (e.g., the upper and/or lower bounds of the difficulty range may be modified after a predefined number of test items have been delivered to the test taker). As will be described, the modification of the test item selection parameters may be performed according to an assessment delivery policy that is based on a multi-armed bandit (MAB) model.

Generally, in an MAB model, every time a test item is presented to a test-taker, a score and reward will be generated based on the test-taker's response. The reward, which may be generated based on a change in a confidence level of an IRT model that is caused by the response. For example, the reward value may be a comparatively higher positive value when the confidence level or reliability of the IRT model increases based on a test-taker's response. The reward value may be a comparatively lower positive value or zero when the confidence level or reliability does not change or decreases based on the test-taker's response. For example, modifying the test item parameters may involve increasing a range of difficulty values that limit such test items when the value of the reward is above a threshold. As another example, modifying the test item parameters may involve shifting, skewing, broadening and/or narrowing an item difficulty probability distribution based on the value of the reward.

At step 410, the server selects the next test item (sometimes referred to here as an “additional test item”) to be delivered to the test taker. For example, the next test item may be selected randomly (e.g. with equal probability of selection for all test items available for selection or according to a defined probability distribution) based on the test item selection parameters that were updated in step 408,

At step 412, the server performs the next test item delivery and response analysis in which the next test item is provided to the test taker and a corresponding response is given by the test taker and received via the client device. A reward value may be determined by the server based on the analysis of the response (e.g., based on how much the response changes a confidence level associated with an IRT model that was used to predict the user's performance when responding to the test item). In some embodiments, the response may include audio data representing a verbal response provided by a test taker, and the analysis of the response may include execution of an automated speech recognition algorithm, which may identify and extract words and/or sentences from the audio data of the response. For example, the delivery and response analysis performed at step 412 may include the steps of the method 500 of FIG. 5, described below.

At step 414, the server determines whether an end condition has been met. For example, the end condition may specify that the method 400 will end if a predetermined number of test items have been delivered to the test taker. As another example, the end condition may specify that the method 400 will end responsive to the server determining that the reliability of the IRT model's estimation of the test-taker's ability level is stable (e.g., a corresponding reliability value calculate by the server each time a response is submitted by the test taker has changed by less than a predetermined amount for the most recent response or a number of most recent responses) or the reliability exceeds a predetermined threshold.

The predetermined number of test items that may define an end condition can be determined via simulation. For example, performance data (e.g., recorded responses and scores) of a group of test takers having previously taken tests having various lengths within a defined range (e.g., around 20-35 items) may be used as the basis for the simulation. A two-parameter (e.g., difficulty and discrimination) IRT model may be constructed based on the performance data, such that each test item represented in the performance data may be assigned a difficulty score and a discrimination score, and each test taker may be assigned an ability level. Then, for each test taker, test delivery is simulated based on the method 400. A regret value may be calculated upon the simulated delivery of each test item. Regret, in the context of decision theory, generally represents a difference between a decision that has been made and an optimal decision that could have been made instead. For each simulated test, a regret curve may be created that comprises the regret value calculated for each test item in the order that the test item was delivered. While the method 400 may decrease the regret value initially, this decrease may become marginal after enough test items have been delivered. Thus, the regret curves may be analyzed to identify a number of test items at which, on average, regret is decreased by less than a predetermined amount (e.g., at which the effect of additional test item delivery on regret may be considered marginal). The identified number may be set as the predetermined number of test items used to define the end condition. It should be understood that such simulation may be similarly performed for the methods 600, 700, 800 described below in connection with FIGS. 6, 7, and 8 (instead of for the method 400 as described here) in order to determine a predetermined number of test items used to define the end condition for those methods.

At step 416, the assessment ends.

FIG. 5 shows an illustrative method 500 by which a test item may be delivered, and a response maybe received and analyzed. For example, some or all of the steps of the method 500 may be executed by one or more computer processors of one or more servers (e.g., servers 112, 307, FIGS. 1, 3) and/or one or more client devices (e.g., client devices 106, 303, FIGS. 1, 3). For example, in order to perform the steps of the method 500, the one or more computer processors may retrieve and execute computer-readable instructions that are stored in one or more memory devices of the one or more servers and/or one or more client devices. It should be understood that the method 500 may be used as a method of test item delivery and response analysis in any of the methods 400, 600, 700, and/or 800 of FIGS. 4, 6, 7, and 8, described herein.

At step 502, a test item is provided to at test taker (e.g., user) by a client device. The test item may be selected at a prior step and may be, for example, selected according to a MAB policy (e.g., based on a difficulty range and/or probability distribution derived from such a MAB policy). For example, the test item may be provided to the test taker by the client device after the client device receives the test item or an identifier associated with the test item from a remote server. The client device may provide the test item to the test taker via audio and/or visual output devices (e.g., speakers and/or electronic displays).

At step 504, the client device receives a response to the test item from the test taker. In a spoken language assessment, the response will generally be a verbal response. The client device may record (e.g., receive and store in memory) the verbal response of the test taker via one or more microphones of the client device.

At step 506, a server may generate a test item score based on the test taker's response to the test item. For example, the server may receive the response from the test taker and may store the response in a memory device of/coupled to the server. The server may then determine the test item score based on the response in comparison to a predetermined set of scoring criteria, which may be also stored in a memory device of/coupled to the server.

For embodiments in which the response is a verbal response (e.g., having been digitally recorded as audio data by the client device), the server may first process the verbal response with a speech recognition algorithm in order to convert the audio data representation of the verbal response into a textual representation of the recognized speech (“recognized speech data”). Such speech recognition algorithms may include Hidden Markov Models (HMM), Gaussian Mixture Models (GMM), neural network models, and/or Dynamic Time Warping (DTW) based models. The server may then proceed to analyze the recognized speech data to generate the test item score. The test item score may be stored in a memory device of/coupled to the server.

At step 508, the server determines a confidence level corresponding to the test item score that was generated at step 506. For example, the confidence level may be or may be based on a reliability value generated from the IRT model using standard errors of difficulty and discrimination estimates for test items made using the IRT model.

At step 510, the server calculates a reward (sometimes referred to as a “reward value”) based on a change in the confidence level. For example, the reward value may be a difference between the confidence level calculated at step 508 (“the current confidence level”) and a confidence level (“the previous confidence level) that was calculated based on the test taker's last response preceding the response received at step 504. The server may store the reward value in a memory device of/coupled to the server. The reward may be used as a basis for adjusting test item selection parameters, such as probability distributions and/or difficulty ranges, as will be described.

FIG. 6 shows an illustrative method 600 by which an assessment may be delivered using a monotonic multi-armed bandit policy to guide test item selection. For example, some or all of the steps of the method 600 may be executed by one or more computer processors of one or more servers (e.g., servers 112, 307, FIGS. 1, 3) and/or one or more client devices (e.g., client devices 106, 303, FIGS. 1, 3). For example, in order to perform the steps of the method 600, the one or more computer processors may retrieve and execute computer-readable instructions that are stored in one or more memory devices of the one or more servers and/or one or more client devices. Test item delivery, according to the method 600, is performed according to a monotonic increase algorithm, such that the server either increases or maintains a range of difficulties that is used to define a pool or group of test items from which test items to be delivered to a student can be selected.

At step 602, the test (“assessment”) begins. For example, the test may be a spoken language adaptive assessment that is automatically scored by a server, and that is delivered to a test taker via a client device.

At step 604, the server generates a random number (e.g., using a random number generation algorithm executed by a processor of the server). The random number may be stored in a memory device of the server.

At step 606, the server selects a test item based on a defined difficulty range and the random number. For example, the test item may be selected from a group of test items within an item bank that is stored in a memory device of the server. The group of test items from which the test item is selected may include only test items having difficulty values (e.g., having previously been determined for each test item using an IRT model) that are within the defined difficulty range. In some embodiments, an initial difficulty range may be predefined and stored in the memory device of the server. This initial difficulty range may be used as the difficulty range during the first iteration of step 606 following the start of a new test.

The random number may be used as a basis for randomly selecting the test item from the group of test items. For example, each test item may be assigned a reference number, and the test item having a reference number that corresponds to the random number itself or to the output of an equation that takes the random number as an input.

At step 608, For example, the delivery and response analysis performed at step 608 may include the steps of the method 500 of FIG. 5, described above.

At step 610, the server determined whether the reward value is greater than or equal to a predetermined reward threshold (e.g., zero) and further determines whether the random number is greater than or equal to a probability threshold.

Generally, the reward value may be exceed the predetermined reward threshold when the test-taker submits a correct response to a test item or their response receives a score that is higher than a predetermined threshold. The reward value may generally be less than the predetermined reward threshold when the test-taker submits an incorrect response to a test item or the test item receives a score that is less than the predetermined threshold.

The probability threshold may be a predetermined value that is stored in the memory device of the server. The probability threshold may control the probabilities with which the difficulty range either stays the same or is shifted to a higher band. For example, increasing the probability threshold would increase the probability that the difficulty range will stay the same, even if a test-taker correctly answers a question. Decreasing the probability threshold would increase the probability that the difficulty range would be shifted to cover a higher band (e.g., shifted to have a higher lower difficulty bound and a higher upper difficulty bound).

If both the reward value is greater than or equal to the predetermined reward threshold and the random number exceeds the probability threshold, the method 600 proceeds to step 612. Otherwise, the method 600 proceeds to step 614.

At step 612, the server updates the difficulty range. As described above, updating the difficulty range may involve shifting the band of difficulty values covered by the difficulty range up, such that one or both of the lower difficulty bound and the upper difficulty bound of the difficulty range are increased.

At step 614, the server determines whether an end condition has been met. For example, the end condition may specify that the method 600 may proceed to step 616 and end if a predetermined number of test items have been delivered to the test taker. The predetermined number of test items defining the end condition may be determined via simulation of the method 600 and corresponding regret analysis, as described above in connection with the method 400 of FIG. 4. As another example, the end condition may specify that the method 600 will end responsive to the server determining that the reliability of the IRT model's estimation of the test-taker's ability level is stable (e.g., a corresponding reliability value calculate by the server each time a response is submitted by the test taker has changed by less than a predetermined amount for the most recent response or a number of most recent responses) or the reliability exceeds a predetermined threshold.

If an end condition has not been met, the method returns to step 604 and a new random number is generated.

At step 616, the assessment ends.

FIG. 7 shows an illustrative method 700 by which an assessment may be delivered using a multi-stage multi-armed bandit policy to guide test item selection. For example, some or all of the steps of the method 700 may be executed by one or more computer processors of one or more servers (e.g., servers 112, 307, FIGS. 1, 3) and/or one or more client devices (e.g., client devices 106, 303, FIGS. 1, 3). For example, in order to perform the steps of the method 700, the one or more computer processors may retrieve and execute computer-readable instructions that are stored in one or more memory devices of the one or more servers and/or one or more client devices. Test item delivery, according to the method 700, is divided into several monotonic cycles or “stages”, with each stage starting with an initial difficulty range, which may be updated or maintained as a test-taker responds to test items within that stage. The difficulty range defines a pool or group of test items from which test items to be delivered to the test-taker are selected by the server. Within a given stage, the difficulty range may be maintained or may be increased according to a monotonic increase algorithm.

At step 702, the test (“assessment”) begins. For example, the test may be a spoken language adaptive assessment that is automatically scored by a server, and that is delivered to a test taker via a client device.

At step 704, the server generates a random number (e.g., using a random number generation algorithm executed by a processor of the server). The random number may be stored in a memory device of the server.

At step 706, the server selects a test item based on a defined difficulty range and the random number. For example, the test item may be selected from a group of test items within an item bank that is stored in a memory device of the server. The group of test items from which the test item is selected may include only test items having difficulty values (e.g., having previously been determined for each test item using an IRT model) that are within the defined difficulty range. In some embodiments, an initial difficulty range may be predefined and stored in the memory device of the server. This initial difficulty range may be used as the difficulty range during the first iteration of step 606 following the start of a new test.

The random number may be used as a basis for randomly selecting the test item from the group of test items. For example, each test item may be assigned a reference number, and the test item having a reference number that corresponds to the random number itself or to the output of an equation that takes the random number as an input.

At step 708, For example, the delivery and response analysis performed at step 708 may include the steps of the method 500 of FIG. 5, described above.

At step 710, the server determines whether the reward value is greater than or equal to a predetermined reward threshold (e.g., zero) and further determines whether the random number is greater than or equal to a probability threshold.

Generally, the reward value may be exceed the predetermined reward threshold when the test-taker submits a correct response to a test item or their response receives a score that is higher than a predetermined threshold. The reward value may generally be less than the predetermined reward threshold when the test-taker submits an incorrect response to a test item or the test item receives a score that is less than the predetermined threshold.

The probability threshold may be a predetermined value that is stored in the memory device of the server. The probability threshold may control the probabilities with which the difficulty range either stays the same or is shifted to a higher band. For example, increasing the probability threshold would increase the probability that the difficulty range will stay the same, even if a test-taker correctly answers a question. Decreasing the probability threshold would increase the probability that the difficulty range would be shifted to cover a higher band (e.g., shifted to have a higher lower difficulty bound and a higher upper difficulty bound).

If both the reward value is greater than or equal to the predetermined reward threshold and the random number exceeds the probability threshold, the method 700 proceeds to step 712. Otherwise, the method 700 proceeds to step 714.

At step 712, the server updates the difficulty range. As described above, updating the difficulty range may involve shifting the band of difficulty values covered by the difficulty range up, such that one or both of the lower difficulty bound and the upper difficulty bound of the difficulty range are increased.

At step 714, the server determines whether a test end condition has been met. For example, the test end condition may specify that the method 700 may proceed to step 716 and end if a predetermined number of test items have been delivered to the test taker in the third stage. The predetermined number of test items defining the end condition may be determined via simulation of the method 700 and corresponding regret analysis, as described above in connection with the method 400 of FIG. 4. It should be understood that, in some embodiments, more or fewer three stages may instead define such an end condition. As another example, the test end condition may specify that the method 700 will end responsive to the server determining that the reliability of the IRT model's estimation of the test-taker's ability level is stable (e.g., a corresponding reliability value calculate by the server each time a response is submitted by the test taker has changed by less than a predetermined amount for the most recent response or a number of most recent responses) or the reliability exceeds a predetermined threshold.

If a test end condition is not determined to have been met, the method 700 proceeds to step 718.

At step 716, the assessment ends.

A step 718, the server determines whether a stage end condition has been met. For example, the stage end condition may specify that the method 700 may proceed to step 720 if a predetermined number of test items have been delivered to the test taker in the current stage (e.g., first stage or second stage). If a stage end condition is not determined to have been met, the method 700 returns to step 704 and a new random number is generated.

At step 720, the server updates the difficulty range. The difficulty range may be updated/increased to a predefined difficulty range corresponding to a particular stage. For example, different initial difficulty ranges may be defined in the memory device of the server for each of the first, second, and third stages. The first time step 720 is performed, the server may set the difficulty range to the predefined initial difficulty range for the second stage. The second time step 720 is performed, the server ay set the difficulty range to the predefined initial difficulty range for the third stage, and so on (e.g., for embodiments in which more than three stages are implemented).

At this step, the server may also increment the stage (e.g., monotonic cycle) that the method 700 is in (e.g., progress from a first stage to a second stage, or progress from a second stage to a third stage). For example, the server may maintain a stage counter in memory, which may initially be set to 1 when the test is started, and which may be incremented each time step 720 is performed, such that the value of the stage counter corresponds to the current stage of the method 700.

Upon completion of step 720, the method returns to step 704, and a new random number is generated.

FIG. 8 shows an illustrative method 800 by which an assessment may be delivered using a probability matching multi-armed bandit policy to guide test item selection. For example, some or all of the steps of the method 800 may be executed by one or more computer processors of one or more servers (e.g., servers 112, 307, FIGS. 1, 3) and/or one or more client devices (e.g., client devices 106, 303, FIGS. 1, 3). For example, in order to perform the steps of the method 800, the one or more computer processors may retrieve and execute computer-readable instructions that are stored in one or more memory devices of the one or more servers and/or one or more client devices. Test-item delivery according to the probability matching policy of the method 800 may involve selection of test items to be delivered to a test-taker based on an estimated ability level of the test taker. An item difficulty probability distribution may be generated by the server based on the test taker's ability level, and test items to be delivered may be selected according to the item difficulty probability distribution.

At step 802, the test (“assessment”) begins. For example, the test may be a spoken language adaptive assessment that is automatically scored by a server, and that is delivered to a test taker (i.e., “user”) via a client device.

At step 804, the server estimates an initial user skill level based on one or more characteristics of the user. Considering the example of a spoken language test, the server may determine, based on information about the user that is stored in a memory device of the server, whether the user is a native speaker or a non-native speaker of the language on which the user is about to be tested, where a native speaker may be assumed to have a higher ability level than a non-native speaker. In some embodiments, the server may analyze previous user behavior (e.g., past performance on tests, assignments, activities, etc.) represented in historical data in order to initially estimate the user's ability level.

In some embodiments, one or more initial test items may be delivered to the student in order to determine the initial user skill level of the user based on the user's performance in responding correctly or incorrectly to these initial test items. For example, a user who performs well (e.g., correctly responds to most or all of the initial test items) may be determined by the server to have a comparatively high initial user skill level. In contrast, a user who performs poorly (e.g., incorrectly responds to most or all of the initial test items) may be determined by the server to have a comparatively low initial user skill level. In some embodiments, the user's responses to such initial test items may be scored and may contribute to the user's overall score on the assessment (e.g., which may provide a “cold start”). In some alternate embodiments, the user's responses to such initial test items may not contribute to the user's overall score on the assessment being delivered (e.g., which may provide a “warm start”), and may instead only be used for the purpose of estimating the user's initial user skill level.

At step 806, the server generates an item difficulty probability distribution based on at least the estimated user skill level. The item difficulty probability distribution may include a range of difficulty values defined by an upper bound and a lower bound, and each difficulty value within the range may be weighted. Generally, difficulty values closer to the center of the item difficulty probability distribution (e.g., 3 if the range is 1 to 5) may be assigned higher weights than difficulty values closer to the upper or lower bounds of the item difficulty probability distributions, although in some embodiments the distribution may instead be skewed in either direction.

At step 808, the server selects a test item randomly according to the item difficulty probability distribution. For example, the server may first select a difficulty value from the distribution with the probability of selecting a given difficulty value being defined by the distribution (e.g., according to the weight assigned to that difficulty value), and may then randomly select a test item from a group of test items of the test item bank stored in the memory device of the server. The group of test items may only include test items having difficulty values equal to that of the selected difficulty value. As an alternative example, the server may randomly select the test item to be delivered from the test item bank according to the probability distribution, such that the probability that a given test item will be selected is defined based on the difficulty value of the given test item in conjunction with the weight assigned to that difficulty value in the item difficulty probability distribution.

At step 810 For example, the delivery and response analysis performed at step 810 may include the steps of the method 500 of FIG. 5, described below.

At step 812, the server updates the estimated user skill level of the user based on whether the user responded correctly or incorrectly to the test item that was most recently delivered at step 810. In some embodiments, the server may generate a non-binary score for the user's response, and this non-binary score may be compared to a threshold value, such that if the non-binary score falls below the threshold value then the value of the estimated user skill level is decreased, and if the non-binary score is above the threshold value then the value of the estimated user skill level is increased.

At step 814, the server updates the item difficulty probability distribution based on the updated estimated user skill level and the reward value. In some embodiments, the item difficulty probability distribution may be updated based only on the reward value. For example, updating the item difficulty probability distribution may include shifting the item difficulty probability distribution up, toward higher difficulty values, if the estimated user skill level increased at step 812, or down, toward lower difficulty values, if the estimated user skill level decreased. Additionally or alternatively, updating the item difficulty probability distribution may include skewing the item difficulty probability distribution positively, if the estimated user skill level decreased, or negatively, if the estimated user skill level increased. Additionally or alternatively, updating the item difficulty probability distribution may include narrowing the range of the item difficulty probability distribution if the estimated user skill level increased or broadening the range of the item difficulty probability distribution if the estimated user skill level decreased.

At step 816, the server determines whether an end condition has been met. For example, the end condition may specify that the method 800 may proceed to step 818 and end if a predetermined number of test items have been delivered to the test taker. The predetermined number of test items defining the end condition may be determined via simulation of the method 800 and corresponding regret analysis, as described above in connection with the method 400 of FIG. 4. As another example, the end condition may specify that the method 800 will end responsive to the server determining that the reliability of the IRT model's estimation of the test-taker's ability level is stable (e.g., a corresponding reliability value calculate by the server each time a response is submitted by the test taker has changed by less than a predetermined amount for the most recent response or a number of most recent responses) or the reliability exceeds a predetermined threshold.

If an end condition has not been met, the method 800 returns to step 808 and another test item is selected for delivery.

At step 818, the assessment ends.

Other embodiments and uses of the above inventions will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

The invention claimed is:

1. A system comprising:
a server that is in electronic communication with a user device associated with a user account, the server comprising:
a processor; and
a memory device configured to store computer-readable instructions, which, when executed, cause the processor to:
initiate an assessment;
select a first test item from a test item bank based on first test item selection parameters;
cause a client device to deliver the first test item;
receive first response data from the client device;
perform analysis of the first response data;
produce second test item selection parameters by modifying the first test item selection parameters based on the analysis of the first response data;
select a second test item from the test item bank based on the second test item selection parameters;
cause the client device to deliver the second test item;
determine that an end condition has been met; and
responsive to determining that the end condition has been met, end the assessment.

2. The system of claim 1, wherein the first response data comprises recorded speech data, wherein performing analysis of the first response data comprises executing a speech recognition algorithm to identify and extract words from the recorded speech data.

3. The system of claim 1, wherein performing analysis of the first response data comprises:
generating a score based on the first response data;
updating an item response theory model based on the score;
updating a confidence level associated with the item response theory model;
responsive to updating the confidence level, determining a change in the confidence level; and
generating a reward value based on the change in the confidence level, wherein the second test item selection parameters are generated based on the score and the reward value.

4. The system of claim 3, wherein the first test item selection parameters comprise a first difficulty range, wherein the second test item selection parameters comprise a second difficulty range, and wherein the computer-readable instructions, when executed, further cause the processor to:
generate a random number;
determine that the reward value exceeds a predetermined threshold;
determine that the random number exceeds a predetermined probability threshold; and
responsive to determining that the reward value exceeds the predetermined threshold and that the random number exceeds the predetermined probability threshold, increasing the first difficulty range of the first test item selection parameters to the second difficulty range of the second test item selection parameters.

5. The system of claim 4, wherein selecting the second test item comprises:
randomly selecting the second test item from a group of test items of the test item bank, wherein the group of test items includes only test items having difficulty values within the second difficulty range, wherein the difficulty values of the test items of the group of test items are calculated using the item response theory model.

6. The system of claim 3, wherein the first test item selection parameters comprise a first probability distribution, wherein the second test item selection parameters comprise a second probability distribution, wherein updating the item response theory model comprises updating a user skill level of a user to which the test is being delivered based on the score, and wherein the computer-readable instructions, when executed, further cause the processor to:
responsive to updating the user skill level, generate the second probability distribution based on the update user skill level and the reward value.

7. The system of claim 6, wherein selecting the second test item comprises:
selecting the second test item from a group of test items of the test item bank according to the second probability distribution, such that a probability of selecting a given test item of the group of test items having a difficulty value determined by the item response theory mode is defined by the second probability distribution.

8. The system of claim 1, wherein determining that the end condition has been met comprises determining that a predetermined number of test items have been delivered.

9. A system comprising:
a server that is in electronic communication with a user device associated with a user account, the server comprising:
a processor; and
a memory device configured to store computer readable instructions, which, when executed, cause the processor to:
initiate an assessment;
generate a random number;
select a first test item based on test item selection parameters and the random number, the first test item selection parameters defining a first difficulty range, wherein the first test item has a first difficulty value that is within the difficulty range;
cause a client device to deliver the first test item;
receive first response data from the client device;
perform analysis of the first response data;
update the test item selection parameters by increasing the first difficulty range to a second difficulty range based on the analysis of the first response data;
generate a second random number;
select a second test item having a second difficulty value within the second difficulty range based on the second random number;
cause the client device to deliver the second test item;
determine that a first end condition has been met; and
end the assessment.

10. The system of claim 9, wherein the first response data comprises recorded speech data, wherein performing analysis of the first response data comprises executing a speech recognition algorithm to identify and extract words from the recorded speech data.

11. The system of claim 9, wherein performing analysis of the first response data comprises:
generating a score based on the first response data;
updating an item response theory model based on the score, wherein the first difficulty value and the second difficulty value are determined based on the item response theory model;
updating a confidence level associated with the item response theory model;
responsive to updating the confidence level, determining a change in the confidence level; and
generating a reward value based on the change in the confidence level, wherein the second test item selection parameters are generated based on the score and the reward value.

12. The system of claim 11, wherein the computer-readable instructions, when executed, further cause the processor to:
determine that the reward value exceeds a predetermined threshold; and
determine that the random number exceeds a predetermined probability threshold, wherein the second difficulty range is generated responsive to determining that the reward value exceeds the predetermined threshold and that the random number exceeds the predetermined probability threshold.

13. The system of claim 9, wherein determining that the first end condition has been met comprises determining that a predetermined number of test items have been delivered.

14. The system of claim 9, wherein the computer-readable instructions, when executed, further cause the processor to:
determine that the first end condition has been met by determining that a first predetermined number of test items have been delivered during a first stage, wherein the first difficulty range has a predefined association with the first stage;
responsive to determining that the first predetermined number of test items have been delivered:
end the first stage,
initiate a second stage, and
update the item selection parameters to include a third difficulty range having a predefined association with the second stage.
generate a third random number;
select a third test item having a third difficulty value within the third difficulty range based on the third random number;
cause the client device to deliver the third test item; and
determine that a second end condition has been met by determining that a second predetermined number of test items have been delivered, wherein ending the assessment is performed responsive to determining that the second end condition has been met.

15. A system comprising:
a server that is in electronic communication with a user device associated with a user account, the server comprising:
a processor; and
a memory device configured to store computer-readable instructions, which, when executed, cause the processor to:
initiate an assessment;
select a first test item from a test item bank based on a first item difficulty probability distribution;
cause a client device to deliver the first test item to a user;
receive first response data from the client device corresponding to a first response submitted by the user;
generate a second item difficulty probability distribution based on the first response data;
select a second test item from the test item bank based on the second item difficulty probability distribution;
cause the client device to deliver the second test item to the user;
determine that an end condition has been met; and
responsive to determining that the end condition has been met, end the assessment.

16. The system of claim 15, wherein the first response data comprises recorded speech data, wherein performing analysis of the first response data comprises executing a speech recognition algorithm to identify and extract words from the recorded speech data.

17. The system of claim 15, wherein the computer-readable instructions, when executed, further cause the processor to:
generate a score based on the first response data;
update an item response theory model based on the score, wherein a first difficulty value of the first test item and a second difficulty value of the second test item are determined based on the item response theory model;
update a confidence level associated with the item response theory model;
responsive to updating the confidence level, determine a change in the confidence level; and
generate a reward value based on the change in the confidence level, wherein the second test item selection parameters are generated based on the score and the reward value.

18. The system of claim 17, wherein updating the item response theory model comprises:
updating a user skill level of the user based on the score, wherein the second item difficulty probability distribution is generated based on the user skill level and the reward value.

19. The system of claim 18, wherein a probability of the second test item being selected is defined by the second probability distribution based on the difficulty value of the second test item.

20. The system of claim 15, wherein determining that the end condition has been met comprises determining that a predetermined number of test items have been delivered to the user via the client device.
